(19) United States
(12) Patent Application Publication
(10) Pub. No.: US 2018/0152737 A1
(43) Pub. Date: May 31, 2018

(54) SYSTEMS AND METHODS FOR MANAGEMENT OF MULTIPLE STREAMS IN A BROADCAST

(71) Applicant: Facebook, Inc., Menlo Park, CA (US)

(72) Inventors: Abhishek Mathur, Menlo Park, CA (US); Dustin John Bramell, Livermore, CA (US); Maher Afif Saba, Seattle, WA (US)

(21) Appl. No.: 15/362,614

(22) Filed: Nov. 28, 2016

(51) Int. Cl. H04N 21/234; H04N 21/235; H04N 21/24; H04N 21/442; H04N 21/2187; H04N 21/485

(52) U.S. Cl. CPC H04N 21/234; H04N 21/235; H04N 21/485; H04N 21/44213; H04N 21/2187; H04N 21/2408

(57) ABSTRACT

Systems, methods, and non-transitory computer readable media are configured to receive specifications associated with a plurality of media content streams associated with a broadcast. The broadcast is configured based at least in part on the specifications. The broadcast is delivered as a presentation of media content associated with the plurality of media content streams through an interface of at least one user device. The presentation of the media content is modified based on user interaction with the media content.

### FIELD OF THE INVENTION

The present technology relates to media content processing. More particularly, the present technology relates to techniques for managing streams of media content relating to a broadcast.

### BACKGROUND

Users often utilize computing devices for a wide variety of purposes. Users can use their computing devices to, for example, interact with one another, access media content, share media content, and create media content. In some cases, media content can be provided by users of a social networking system. The media content can include one or a combination of text, images, videos, and audio. The media content may be published to the social networking system for consumption by others.

Under conventional approaches, media content can be broadcast by a publisher through a broadcast platform, such as a social networking system. In one example, a broadcast can involve a media content stream associated with an event (e.g., live event, concert, TV show premiere, a sporting event, etc.) that is captured by a publisher and then provided to the broadcast platform. The media content stream, in turn, can be encoded by the broadcast platform and delivered by the broadcast platform to user devices over a network (e.g., the Internet) in real-time.

### SUMMARY

Various embodiments of the present technology can include systems, methods, and non-transitory computer readable media configured to receive specifications associated with a plurality of media content streams associated with a broadcast. The broadcast is configured based at least in part on the specifications. The broadcast is delivered as a presentation of media content associated with the plurality of media content streams through an interface of at least one user device. The presentation of the media content is modified based on user interaction with the media content.

In some embodiments, the broadcast is a live broadcast.

In some embodiments, the plurality of media content streams include at least one of a video stream and an audio stream.

In some embodiments, the specifications are provided by a content provider of the plurality of media content streams.

In some embodiments, the specifications comprise at least one of a title or description associated with a media content stream, an aspect ratio associated with a media content stream, and a resolution associated with a media content stream.

In some embodiments, configuration of the broadcast comprises determining setup information for a content provider of the plurality of media content streams, the setup information allowing the content provider to initiate delivery of the broadcast.

In some embodiments, the setup information comprises at least one of a broadcast ID, a security key, and a URI for each media content stream of the plurality of media content streams.

In some embodiments, at least one media content stream of the plurality of media content streams is adapted based on contextual data. The contextual data comprises at least one of constraints associated with the at least one user device and network connectivity relating to the at least one user device. The adaptation comprises modifying metadata associated with the at least one media content stream.

In some embodiments, the presentation of the media content comprises display of media content associated with a first media content stream in a first view that is more prominent than display of media content associated with a second media content stream in a second view. The modification of the presentation of the media content comprises, in response to a selection of the media content associated with the second media content stream in the second view, changing display of the media content associated with the second media content stream to be more prominent than the display of the media content associated with the first media content stream.

In some embodiments, the modification of the presentation of the media content further comprises, in response to a second selection of the media content associated with the second media content stream in the second view, causing full screen display of the media content associated with the second media content stream.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example broadcast management module, according to an embodiment of the present technology.

FIG. 2 illustrates an example broadcast setup module, according to an embodiment of the present technology.

FIG. 3 illustrates an example broadcast delivery module, according to an embodiment of the present technology.

FIG. 4A illustrates an example interface for specifying a broadcast, according to an embodiment of the present technology.

FIGS. 4B-4D illustrate an example interface for presenting a broadcast, according to an embodiment of the present technology.

FIG. 5 illustrates an example method relating to presentation of a broadcast, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Multiple Stream Management for Event Broadcast

As mentioned, users often utilize computing devices for a wide variety of purposes. Users can use their computing devices to, for example, interact with one another, access media content, share media content, and create media content. In some cases, media content can be provided by users of a social networking system. The media content can include one or a combination of text, images, videos, and audio. The media content may be published to the social networking system for consumption by others.

Under conventional approaches, media content can be broadcast by a publisher through a broadcast platform, such as a social networking system. In one example, a broadcast can involve a media content stream associated with an event (e.g., live event, concert, TV show premiere, a sporting event, etc.) that is captured by a publisher and then provided to the broadcast platform. The media content stream, in turn, can be encoded by the broadcast platform and delivered by the broadcast platform to user devices over a network (e.g., the Internet) in real-time. Such conventional approaches that support a broadcast of a media content stream for an event can pose significant disadvantages. For example, such a broadcast typically includes a single media content stream to cover the event. In many instances, an event is not optimally captured by a single media content stream alone. Rather, complexity or magnitude of an event can favor multiple media content streams reflecting different angles or views and other media content parameters to adequately cover multiple dimensions of the event for various types of user devices. Moreover, such conventional approaches typically fail to allow users to interact with the broadcast or select a desired presentation of available angles or views of an event.

An improved approach rooted in computer technology overcomes the foregoing and other disadvantages associated with conventional approaches specifically arising in the realm of computer technology. Systems, methods, and computer readable media of the present technology can allow a content provider (e.g., broadcaster, publisher, etc.) to provide a live (or near live) broadcast based on multiple media content streams associated with an event. The media content streams can reflect different angles, views, or subject matter associated with the event. Further, the media content streams associated with an event can correspond to different parameters relating to, for example, various aspect ratios, various resolutions, and the like. Through an interface provided by a broadcast platform, such as a social networking system, a content provider can specify parameters for the broadcast. For example, the content provider can specify the various media content streams as well as related metadata about each media content stream. The metadata relating to each media content stream can include, for example, a title or description, an aspect ratio, a resolution, etc. In response to specification of the media content streams and their related metadata, the broadcast platform can configure a broadcast and return setup information, including a broadcast identification, a security key, and a URI for each media content stream. The content provider can use the setup information to initiate a broadcast of the event through the broadcast platform. Based on contextual data, the broadcast platform can adapt a configuration of the media content streams to optimize the broadcast. The broadcast platform can deliver the broadcast by streaming the media content streams for presentation on user devices based at least in part on the metadata related to the media content streams. Through interaction with views of media content associated with the media content streams, users can alter the presentation of the media content according to their preferences. More details regarding the present technology are described herein.

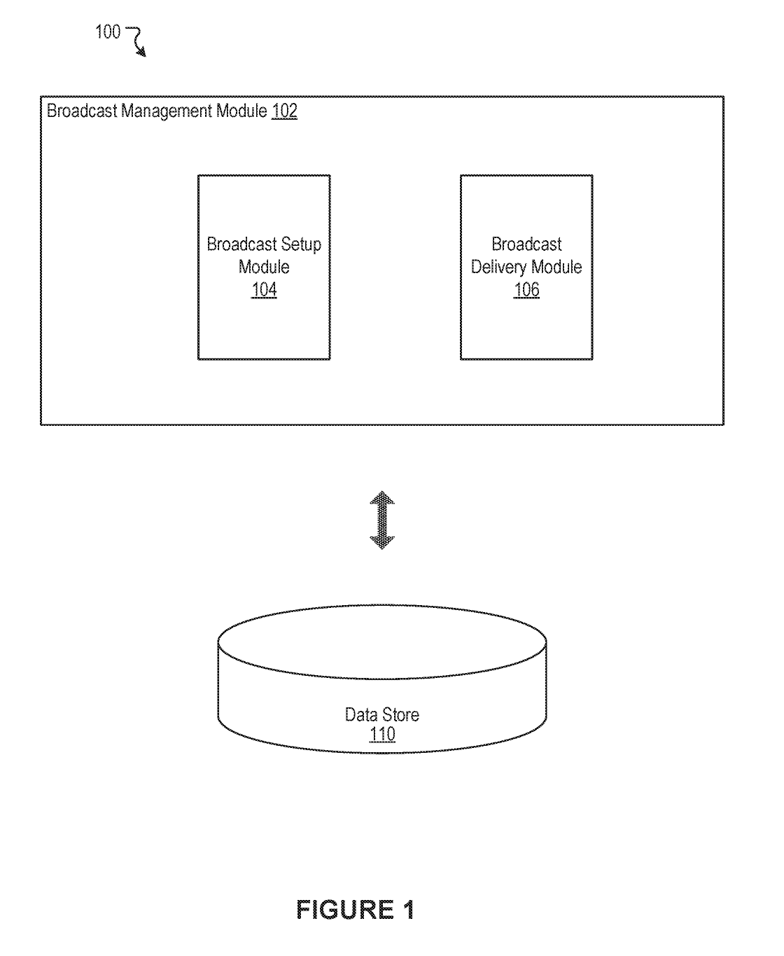

FIG. 1 illustrates an example system 100 including an example broadcast management module 102 configured to provide a live (or near live) broadcast based on a plurality of media content streams associated with an event, according to an embodiment of the present technology. The broadcast management module 102 can be implemented on a broadcast platform, such as a social networking system. The broadcast management module 102 can allow a content provider (e.g., a broadcaster, publisher, etc.) to specify a plurality of media content streams associated with an event for provision to the broadcast platform. The content provider also can specify metadata relating to the plurality of media content streams. The broadcast platform can adapt a configuration of the plurality of media content streams based on contextual data to optimize the broadcast to one or more user devices. The broadcast platform can provide setup information to the content provider to allow initiation of the broadcast. When initiated by the content provider, the broadcast causes media content associated with the plurality of media content streams to be presented on user devices associated with users who are receiving the broadcast. The users can interact with media content and change presentation of the media content as desired. As used herein, a content provider can be any entity of a social networking system, such as a user, a page, a group, or an event, and information regarding creation of a broadcast by the content provider can appear on page associated with the content provider on the social networking system. In accordance with the present technology, a media content stream relating to a broadcast can be any type of media content stream. Types of media content streams can include, for example, video streams (e.g., 2D video, 360 video, virtual reality (VR) environments, etc.), audio streams, any other form of media content stream, or any combination thereof. While some of the examples described herein relate to video streams, the present technology can apply to audio streams and other types of media content streams as well. In addition, while some of the examples described herein relate to a live broadcast, the present technology also can apply to video on demand (VOD).

The broadcast management module 102 can include a broadcast setup module 104 and a broadcast delivery module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the broadcast management module 102 can be implemented in any suitable combinations.

The broadcast setup module 104 can allow a content provider to specify information about a broadcast to be delivered through a broadcast platform. The content provider can specify the plurality of media content streams associated with a broadcast as well as metadata related to each media content stream. The broadcast setup module 104 can configure a broadcast based on the information specified by the content provider. Configuration of the broadcast can include the generation of setup information that allows the content provider to initiate the broadcast through the broadcast platform. The broadcast setup module 104 can adapt the plurality of media content streams based on contextual data to optimize the broadcast for user devices receiving the broadcast. Functionality of the broadcast setup module 104 is described in more detail herein.

The broadcast delivery module 106 can deliver a plurality of media content streams associated with an event as a broadcast presented to user devices. The broadcast delivery module 106 can initially cause presentation of media content associated with the plurality of media content streams in a default manner based on specified metadata related to the plurality of media content streams. User interaction with the media content, such as selection of certain views of the media content, can cause the presentation of the media content to change. Functionality of the broadcast delivery module 106 is described in more detail herein.

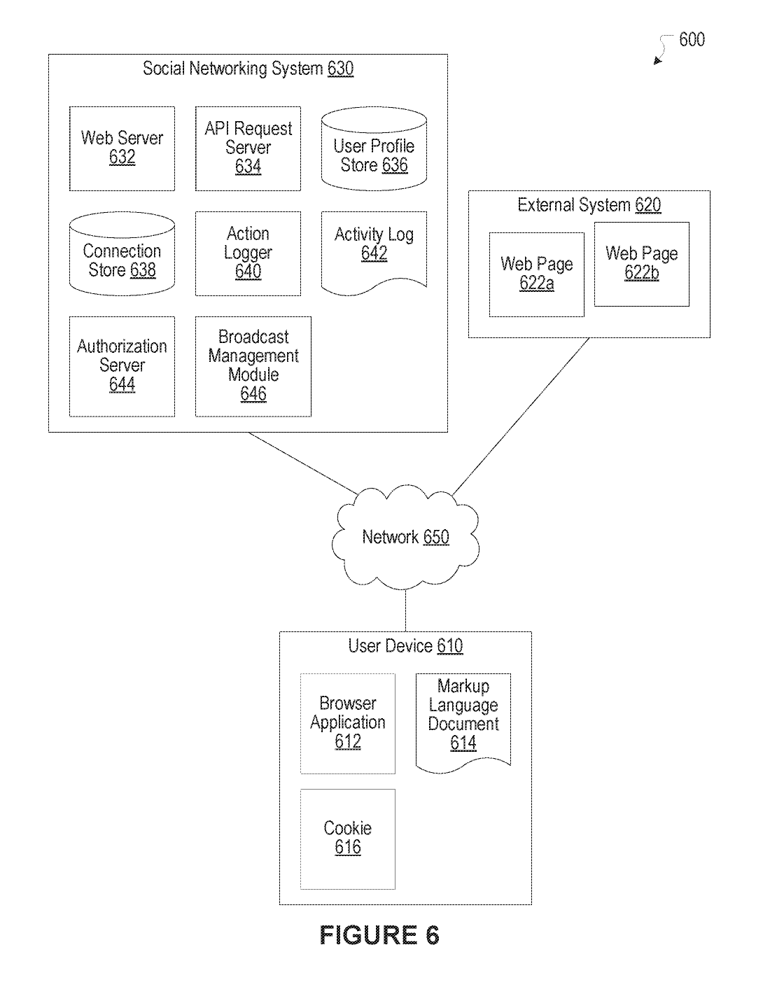

In some embodiments, the broadcast management module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the broadcast management module 102 can be, in part or in whole, implemented as software running on one or more computing devices or systems, such as on a server or a client computing device. For example, the broadcast management module 102 can be, in part or in whole, implemented within or configured to operate in conjunction or be integrated with a social networking system (or service), such as a social networking system 630 of FIG. 6. As another example, the broadcast management module 102 can be implemented as or within a dedicated application (e.g., app), a program, or an applet running on a user computing device or client computing system. In some instances, the broadcast management module 102 can be, in part or in whole, implemented within or configured to operate in conjunction or be integrated with client computing device, such as a user device 610 of FIG. 6. It should be understood that many variations are possible.

The system 100 can include a data store 110 configured to store and maintain various types of data, such as data relating to support of and operation of the broadcast management module 102. The data store 110 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the broadcast management module 102 can be configured to communicate and/or operate with the data store 110.

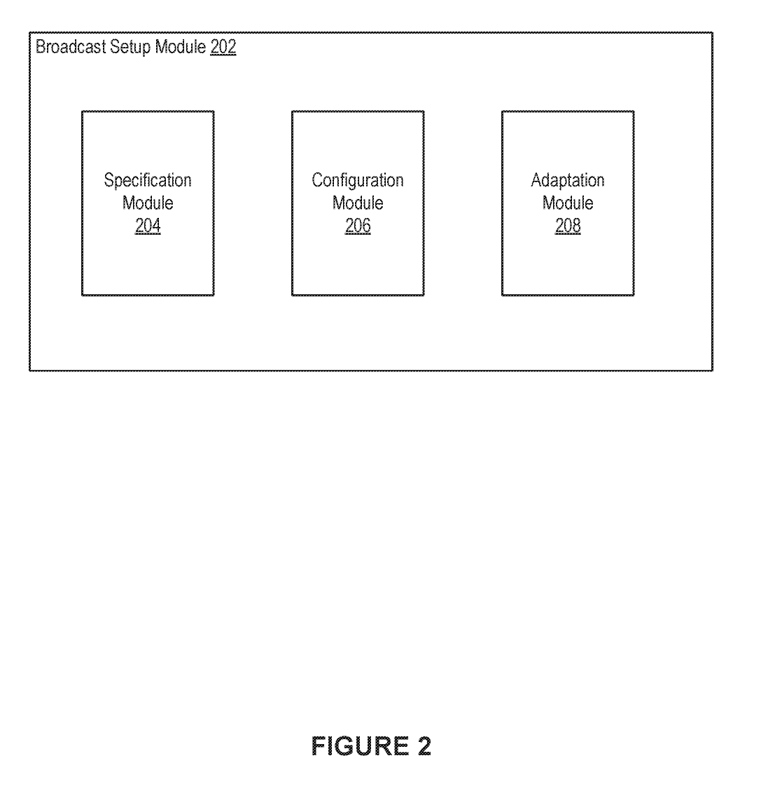

FIG. 2 illustrates an example broadcast setup module 202, according to an embodiment of the present technology. In some embodiments, the broadcast setup module 104 of FIG. 1 can be implemented with the broadcast setup module 202. The broadcast setup module 202 can include a specification module 204, a configuration module 206, and an adaptation module 208.

The specification module 204 can allow a content provider to specify information regarding a plurality of media content streams associated with an event to be broadcast and metadata (or parameters, attributes, etc.) related to the plurality of media content streams. In some embodiments, the specified information can be provided to a broadcast platform through a suitably configured application programming interface (API) supported by the broadcast platform. In some embodiments, the content provider can specify each media content stream in the plurality of media content streams. For each media content stream, the content provider also can specify metadata related to the media content stream. The metadata can include, for example, a title or description (or label), an aspect ratio, a resolution, etc. A title or description of a media content stream, such as a video stream, can indicate, for example, a particular angle, particular view, or particular subject matter relating to an event to be broadcast or a level of relative importance of the media content stream in relation to other media content streams in the plurality of content streams. For example, a title or description can indicate a “primary view” (or “main view”, “stage view”, “center view”, etc.), “secondary view” (“left view”, “right view”, “side view”, “field view”, “balcony”, “locker room”, etc.), “tertiary view” (or “back view”, etc.), and so on. In some embodiments, a title or description associated with a media content stream can indicate that the media content stream is intended only as a backup for another primary media content stream. For example, a secondary media content stream can be streamed for presentation as a backup instead of an associated primary media content stream if streaming and broadcast of the primary media content stream ceases or is interrupted. An aspect ratio of a media content stream can indicate any aspect ratio reflected in the media content stream, such as 1:1, 4:3, 9:16, 16:9, 21:9, or any other aspect ratio value. A resolution of a media content stream can indicate any type of resolution, such as HD (high definition), SD (standard definition), LD (low definition), etc. In some embodiments, a media content stream itself can constitute a sequence of joined media content streams. For example, the joined media content streams can be captured by different media content capture devices (e.g., cameras, microphones, etc.) and stitched together to constitute a media content stream.

Each media content stream of a plurality of media content streams can be unique or share metadata with other media content streams. In some embodiments, a content provider can specify a plurality of media content streams such that each media content stream is unique. For example, a content provider can specify a first media content stream associated with a first title or description (e.g., “primary view”), a first aspect ratio (e.g., 1:1), and a first resolution (e.g., HD); a second media content stream associated with a second title or description (e.g., “side view”), a second aspect ratio (e.g., 4:3), and a second resolution (e.g., SD); and, a third media content stream associated with a third title or description (e.g., “rear view”), a third aspect ratio (e.g., 16:9), and a third resolution (e.g., LD). In some embodiments, a content provider can specify a plurality of media content streams that may be associated with common metadata. For example, a content provider can specify a first media content stream associated with a first title or description (e.g., “primary view”), a first aspect ratio (e.g., 1:1), and a first resolution (e.g., HD); a second media content stream associated with a second title or description (e.g., “primary view”), a second aspect ratio (e.g., 1:1), and a second resolution (e.g., LD); and, a third media content stream associated with a third title or description (e.g., “peripheral view”), a third aspect ratio (e.g., 1:1), and a third resolution (e.g., LD). The specification module 204 can support any variety of media content streams associated with an event. Further, the specification module 204 can support any combinations of metadata associated with the media content streams to accommodate a wide spectrum of broadcast preferences or optimizations. In some embodiments, the content provider can modify metadata related to a plurality of media content streams after delivery of the plurality of media content streams has begun. For example, the content provider can specify, for one or more media content streams, changes to their associated title or description. In one illustration, a content provider can change an original title or description of “primary” associated with a first media content stream to “secondary”, and an original title or description of “secondary” associated with a second media content stream to “primary”. As a result, presentation of media content associated with the media content streams will change such that media content associated with the secondary media content stream will be presented as primary while media content associated with the first media content stream will be presented as secondary, as discussed in more detail herein. In some embodiments, the content provider also can specify a target audience of users with selected attributes to receive a broadcast. The broadcast can be delivered based on the target audience. The selected attributes can include certain categories of demographic information (e.g., age, gender, location, etc.).

In some embodiments, the broadcast platform can specify constraints for a plurality of media content streams associated with a broadcast. The constraints can be preferences or requirements of the broadcast platform for delivery of an optimal broadcast, such as a live broadcast. For example, the constraints can relate to video format, video length, or advanced settings. The video format can relate to, for example, maximum resolution at a selected frames per second, a key frame (or I-frame) rate, a maximum bit rate, a maximum character length of a title, and encoding formats (e.g., H264, AAC). The video length can relate to, for example, a maximum time length of a live media content stream and a maximum length for preview streams. The advanced settings can relate to, for example, a pixel aspect ratio, frame types (e.g., progressive scan), audio sample rate, audio bitrate, and bitrate encoding (e.g., CBR).

The configuration module 206 can configure a broadcast based on information specified by a content provider in relation to a plurality of media content streams associated with a broadcast. In response to the specified information, the configuration module 206 can return broadcast setup information through an interface presented to the content provider. The setup information can allow the content provider to initiate a broadcast. The broadcast setup information can include, for each broadcast, a broadcast ID (identification), a security key, and a URI (universal resource identifier) associated with each media content stream of the plurality of media content streams associated with the broadcast. In some embodiments, the security key can be appended in the URIs associated with the plurality of media content streams. The broadcast setup information can be used by the content provider to setup media content streaming to the broadcast platform.

In some embodiments, a broadcast can be configured for presentation as a plurality of views corresponding to a plurality of media content streams based on information specified by a content provider, as discussed. In an example relating to four media content streams associated with a broadcast, a first media content stream can be specified to have a first title or description, a first aspect ratio, and a first resolution; a second media content stream can be specified to have a second title or description, a second aspect ratio, and a second resolution; a third media content stream can be specified to have a third title or description, a third aspect ratio, and a third resolution; and, a fourth media content stream can be specified to have a fourth title or description, a fourth aspect ratio, and a fourth resolution. In this example, the configuration module 206 can configure the broadcast based on the specified information so that media content associated with the first media content stream is presented as a first view reflecting the first title or description, the first aspect ratio, and the first resolution; media content associated with the second media content stream is presented as a second view reflecting the second title or description, the second aspect ratio, and the second resolution; media content associated with the third media content stream is presented as a third view reflecting the third title or description, the third aspect ratio, and the third resolution; and, media content associated with the fourth media content stream is presented as a fourth view reflecting the fourth title or description, the fourth aspect ratio, and the fourth resolution. Broadcasts associated with a different number of media content streams can be likewise presented.

The adaptation module 208 can adapt a configuration of a plurality of media content streams before or during delivery of an associated broadcast. The adaptation module 208 can adapt a configuration of a plurality of media content streams associated with a broadcast based on various considerations. In some embodiments, such considerations can include contextual data. Contextual data can include, for example, constraints relating to user devices for receiving the broadcast (e.g., user device screen dimensions, user device orientation, etc.) and network connectivity of the user devices (e.g., bandwidth, connection charges, etc.). Contextual data can include actual or expected contextual data associated with a particular user device. Based on the contextual data, the adaptation module 208 can select one or more media content streams of a plurality of media content streams for presentation on a particular user device while one or more other media content streams are not selected for presentation. In addition, the adaptation module 208 can process, modify, or otherwise adapt a media content stream so that the media content stream and associated metadata is matched with the contextual data associated with a particular user device. In some embodiments, the adaptation module 208 can automatically generate adaptations of original media content streams provided by a content provider. The adaptations of original media content streams can include, for example, media content streams associated with aspect ratios and resolutions different from aspect ratios and resolutions associated with the original media content streams. The adaptation module 208 can perform conventional editing or encoding techniques on original media content streams to generate adaptations of the original media content streams.

In an example, for a particular broadcast, assume that a first media content stream of a plurality of media content streams can be specified to have an associated first title or description (e.g., “stage angle”), first aspect ratio (e.g., 16:9), and first resolution (e.g., HD) and a second media content stream can be specified to have an associated second title or description (e.g., “stage angle”), second aspect ratio (e.g., 9:16), and second resolution (e.g., HD). In one instance, the adaptation module 208 can obtain contextual data indicating that a screen of a particular user device, such as a tablet or mobile phone, to receive the broadcast is currently positioned in a vertical (or portrait) orientation. As a result, the adaptation module 208 can adapt a configuration of the broadcast for the user device by selecting the second media content stream for delivery instead of the first media content stream based on the second aspect ratio associated with the second media content stream and its match with a vertical orientation of the user device. If the contextual data indicates that the user device at a later time in the broadcast is positioned in a horizontal (or landscape) orientation, the adaptation module 208 can again adapt the configuration of the broadcast by selecting the first media content stream for delivery instead of the second media content stream based on the first aspect ratio associated with the first media content stream and its match with the horizontal orientation of the user device. The adaptation module 208 likewise can tailor a configuration of the plurality of media content streams for other user devices receiving the broadcast based on their associated contextual data.

In another example, the adaptation module 208 can obtain contextual data indicating that a screen of a particular user device has dimensions m×n, where m and n represent, respectively, a value of width and a value of height. The adaptation module 208 can determine that the screen dimensions m×n are a poor or incompatible match for the first media content stream and the second media content stream in view of their respective aspect ratios. An aspect ratio associated with a media content stream that is matched to screen dimensions can optimize presentation of a broadcast and related user experience. As a result, the adaptation module 208 can adapt a configuration of the broadcast for the user device to include a third media content stream specified to have a third aspect ratio that matches dimensions m×n. The third media content stream can be generated by the broadcast platform based on application of conventional editing techniques on the first media content stream or the second media content stream. The third media content stream can be delivered for presentation in the broadcast for the user device instead of the first media content stream and the second media content stream.

In yet another example, the adaptation module 208 can obtain contextual data indicating that network connectivity of a particular user device is relatively low (e.g., below a threshold value). A lower resolution for a media content stream in view of relatively low network connectivity can optimize the broadcast and related user experience. As a result, the adaptation module 208 can adapt a configuration of the broadcast for the user device to include a third media content stream specified to have an associated third resolution (e.g., LD) that can be lower than the resolution associated with the first media content stream and the second media content stream. The third media content stream can be generated by the broadcast platform based on application of conventional editing techniques on the first media content stream or the second media content stream. The third media content stream can be delivered for presentation in the broadcast for the user device instead of the first media content stream and the second media content stream. The adaptation module 208 can select from a plurality of media content streams or modify the plurality of media content streams in any variety of manners to adapt a configuration of the plurality of media content streams to optimize an associated broadcast based on contextual data. Many variations are possible.

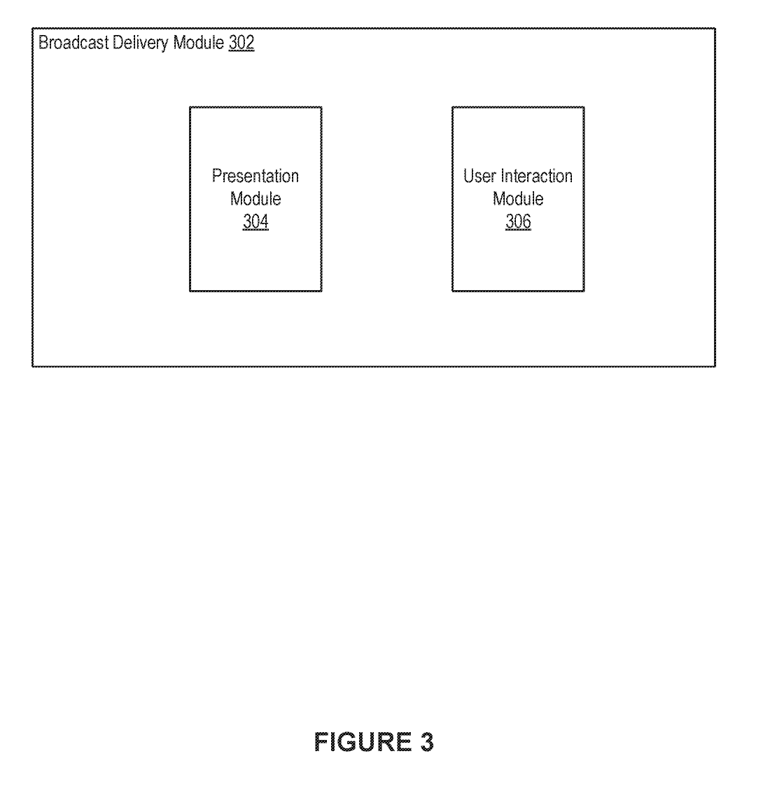

FIG. 3 illustrates an example broadcast delivery module 302, according to an embodiment of the present technology. In some embodiments, the broadcast delivery module 106 of FIG. 1 can be implemented with the broadcast delivery module 302. The broadcast delivery module 302 can include a presentation module 304 and a user interaction module 306.

The presentation module 304 can deliver a broadcast associated with a plurality of media content streams as configured by a broadcast platform to one or more user devices. When delivering a live broadcast, the presentation module 304 can utilize any generally known techniques that allow for live streaming of media content including, for example, the Real Time Messaging Protocol (RTMP). In some embodiments, a plurality of media content streams associated with a broadcast can be delivered for presentation on an interface of an application running on a user device and through an appropriately configured media content player. In some embodiments, a broadcast can be presented such that media content associated with the plurality of media content streams are simultaneously displayed in separate respective windows or views of the interface. In some embodiments, the interface can be a single page or screen on which all media content associated with the plurality of media content streams is presented. In other embodiments, the interface can be multiple pages or screens on which media content associated with the plurality of media content streams are presented.

The media content associated with the plurality of media content streams can be presented based on metadata associated with the plurality of media content streams. For example, assume that a broadcast is configured so that a first media content stream of a plurality of media content streams is associated with a first title or description (e.g., “primary view”), first aspect ratio (e.g., 4:3), and first resolution (e.g., SD); a second media content stream is associated with a second title or description (e.g., “left view”), second aspect ratio (e.g., 4:3), and second resolution (e.g., SD); and, a third media content stream is associated with a third title or description (e.g., “right view”), third aspect ratio (e.g., 4:3), and third resolution (e.g., SD). In this example, the presentation module 304 can arrange presentation of media content through an interface implemented on a user device so that media content associated with the first media content stream is displayed most prominently based on the “primary view” designation. For example, media content associated with the first media content stream can be highlighted or enlarged in relation to media content associated with other media content streams. Further, the presentation module 304 can arrange presentation so that media content associated with the second media content stream is displayed to the left of the media content associated with the first media content stream based on the “left view” designation and media content associated with the third media content stream is displayed to the right of the media content associated with the first media content stream based on the “right view” designation.

The user interaction module 306 can alter presentation of media content associated with a plurality of media content streams based on user interaction with the media content through the interface. As referenced, a broadcast can be initially presented in a default manner through an interface on a user device based on a configuration of a plurality of media content streams. In some embodiments, based on user interaction with the media content displayed on the interface, the presentation of the broadcast can change. In this regard, a broadcast can initially present on a user device media content associated with a plurality of media content streams based on related metadata. Accordingly, media content associated with a media content stream designated as primary can be initially displayed more prominently or larger than other media content. Media content associated with media content streams designated as secondary, tertiary, and so on can be initially displayed less prominently or smaller than media content associated with a media content stream designated as primary. If a user selects though a user gesture (e.g., touch, click, gaze, etc.) media content associated with, for example, a media content stream designated as secondary, display of the media content associated with the media content stream designated as secondary can continue to be displayed simultaneously with the other media content. However, based on the selection, the media content associated with the media content stream designated as secondary can be displayed more prominently or larger than other media content, including the media content associated with the media content stream designated as primary. If a user selects again the media content associated with the media content stream designated as secondary, the media content associated with the media content stream designated as secondary can be displayed in a full screen manner to generate an immersive or near immersive user experience such that media content associated with other media content streams are no longer simultaneously displayed. The user interaction module 306 can further modify presentation of media content associated with media content streams in response to other user interactions in a variety of manners.

The user interaction module 306 also can allow a user to selectively direct a plurality of media content streams associated with a broadcast to various user devices. In some embodiments, the various user devices can be associated with or under control of the user. In some embodiments, a user can provide instructions or commands to an interface through which the broadcast is presented. The instructions or commands can selectively direct one or more media content streams of the plurality of media content streams to one or more user devices of a plurality of user devices. For example, the instructions or commands provided by the user can cause the broadcast platform to direct a first media content stream associated with the broadcast to a first user device (e.g., mobile phone), a second media content stream associated with the broadcast to a second user device (e.g., tablet), a third media content stream associated with a third user device (e.g., desktop computer), and so on. As another example, the instructions or commands by the user can cause the broadcast platform to direct a first media content stream and a second media content stream to a first user device, a third media content stream to a second user device, and a fourth media content stream to a third user device. In some embodiments, a media content stream of the plurality of media content streams can be automatically directed (without an instruction or command by the user) to a particular user device based on metadata associated with the media content stream and its match with the user device or contextual data relating to the user device.

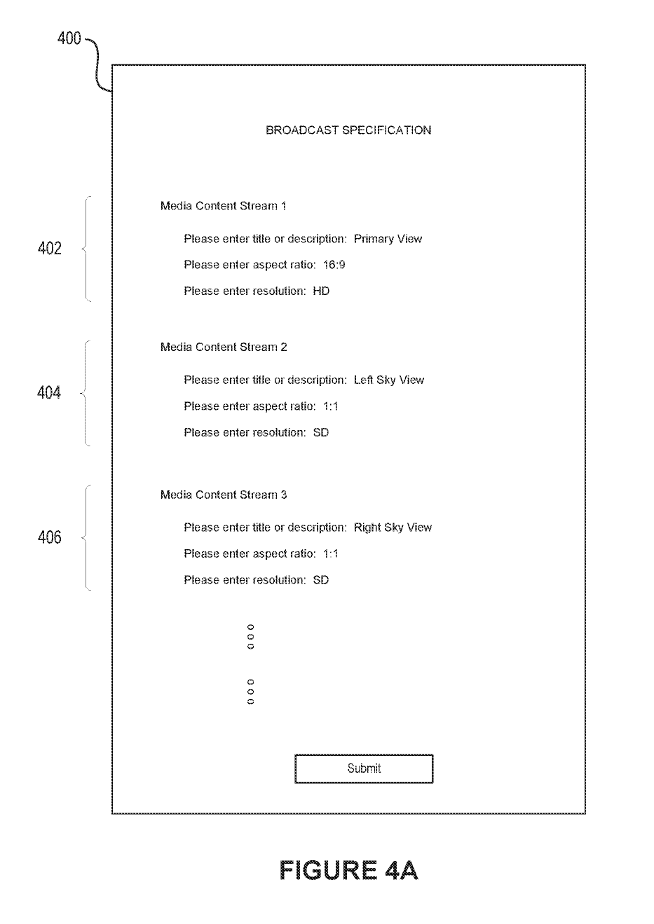

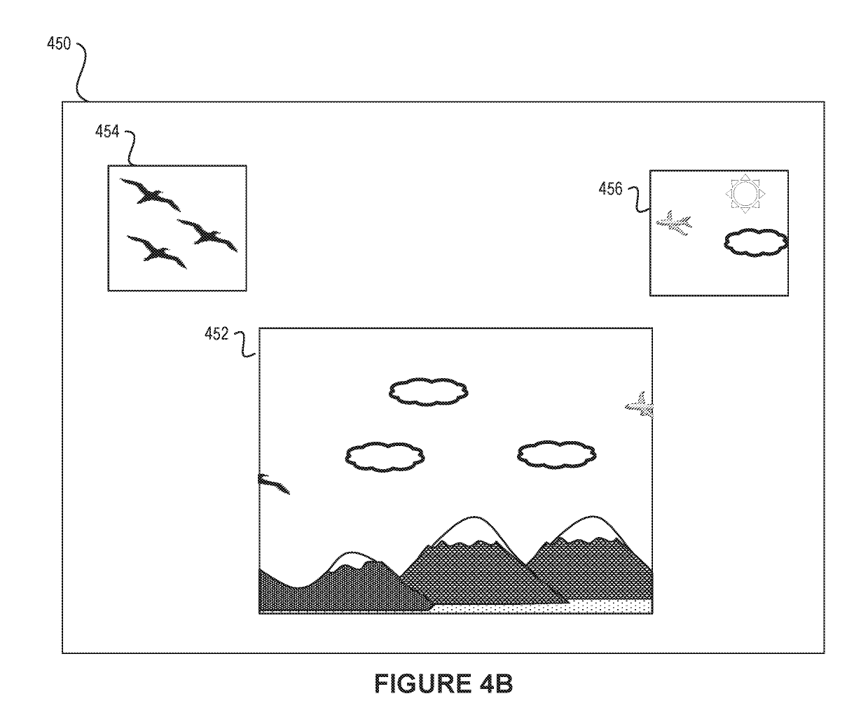

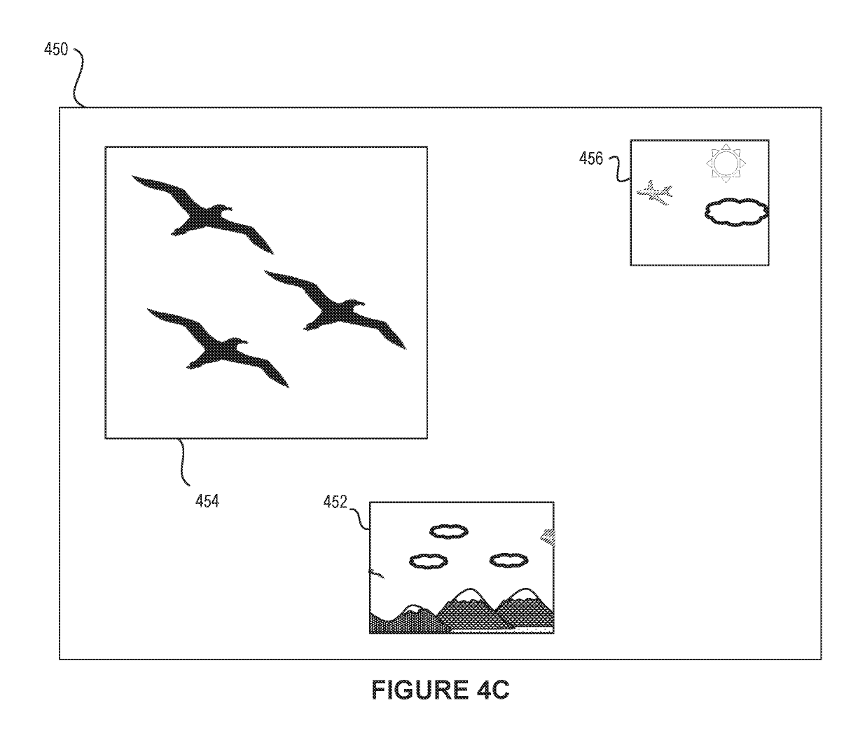

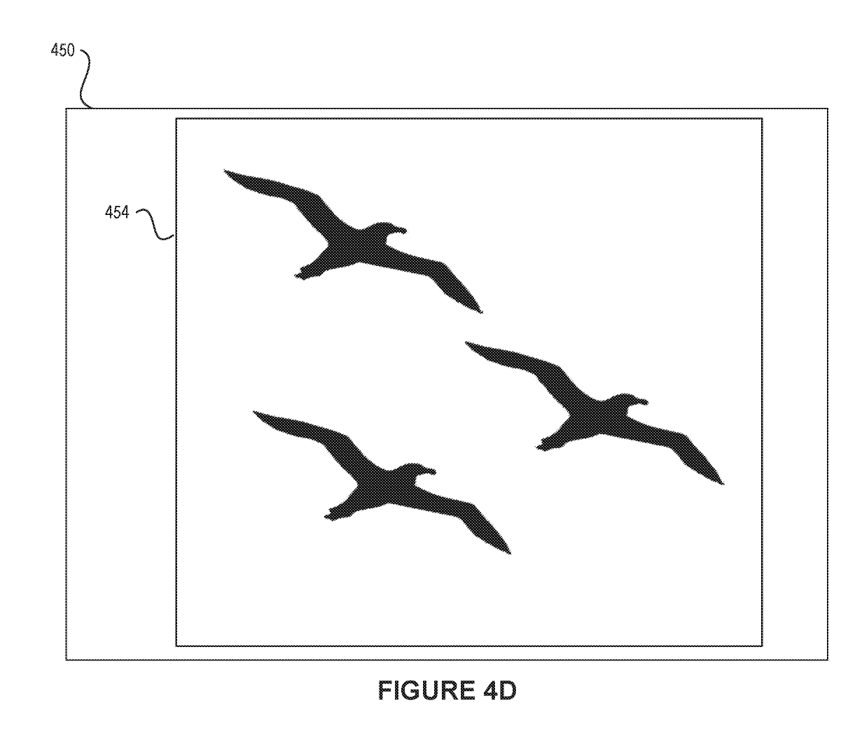

FIG. 4A illustrates a first example interface 400, according to an embodiment of the present technology. The interface 400 can allow a content provider to specify a plurality of media content streams associated with a broadcast as well as related metadata (or parameters). The metadata can include any information relating to a media content stream, such as title or description, aspect ratio, resolution, or other relevant information. The content provider can provide through the interface 400 specifications 402, 404, 406 for, respectively, a first media content stream, a second media content stream, and a third media content stream of the plurality of media content streams. While three media content streams are shown in the example, any suitable number of media content streams constituting a broadcast can be specified. As shown, the specification 402 relating to the first media content stream indicates that the content provider has specified “Primary View” as the title or description, “16:9” as the aspect ratio, and “HD” as the resolution. The specification of “Primary View” can indicate that the first media content stream is primary in comparison with other media content streams associated with the broadcast. Accordingly, the broadcast management module 102 can cause display of media content associated with the first media content stream to be more prominent than other media content. In addition, the specification 404 relating to the second media content stream indicates that the content provider has specified “Left Sky View” as the title or description, “1:1” as the aspect ratio, and “SD” as the resolution. Likewise, the specification 406 relating to the third media content stream indicate that the content provider has specified “Right Sky View” as the title or description, “1:1” as the aspect ratio, and “SD” as the resolution. The specification of “Left Sky View” and “Right Sky View” for, respectively, the second media content stream and the third media content stream can indicate that these media content streams are non-primary (or secondary). Accordingly, the broadcast management module 102 can cause display of media content associated with the second media content stream and the third media content stream to be less prominent in comparison to the media content associated with the first media content stream. A configuration of the broadcast can be based on the specifications 402, 404, 406. In other examples, a content provider can specify other media content streams associated with other metadata. In some embodiments, the broadcast management module 102 can adapt a configuration of the media content streams based on contextual data to optimize a broadcast to one or more user devices, as discussed in more detail herein. Setup information can be provided to the content provider to allow the content provider to initiate a broadcast of the plurality of media content streams. In some embodiments, the setup information can include, for example, a broadcast ID, a security key, and a URI for each media content stream in the plurality of media content streams. The content provider can initiate the broadcast with the setup information.

FIG. 4B illustrates an example interface 450, according to an embodiment of the present technology. The interface 450 can be implemented on a user device for presenting a broadcast. As shown, the interface 450 includes a view 452 of media content associated with a first media content stream, a view 454 of media content associated with a second media content stream, and a view 456 of media content associated with a third media content stream. The first media content stream, the second media content stream, and the third media content stream were specified by a content provider to constitute a broadcast of an event. Respective media content shown in the views 452, 454, 456 are presented simultaneously. As shown, the arrangement of the views 452, 454, 456 on the interface 450 places the view 452 at a center position and places the views 454, 456 at lateral positions. The view 452 is placed at a center position and shown as more prominent or larger than the view 454 and the view 456 because metadata specified by the content provider indicates that the first media content stream is primary while the second media content stream and the third media content are non-primary (e.g., secondary). In this example, the view 454 and the view 456 appear laterally in relation to the view 452 because the second media content stream and the third media content stream were specified as, respectively, a left view and a right view in relation to the first media content stream. In other embodiments, the views 452, 454, 456 can be presented with captions or labels that convey a title or description associated with each view as specified by the content provider.

FIG. 4C illustrates the example interface 450, according to an embodiment of the present technology. Based on user interaction with presentation of the broadcast through the interface 450 on a user device, the presentation of the broadcast can change. In this example, a user associated with the user device has selected the view 454. The selection can indicate a user preference to make the view 454 primary, instead of the view 452. As a result, the view 454 of the media content associated with the second media content stream is shown more prominently than before and the view 452 is reduced in prominence. In the example shown, after the selection, the views 452, 454, 456 continue to be simultaneously presented and the relative positions of the views 452, 454, 456 are maintained. In other examples, presentation of the views 452, 454, 456 can change after the selection. For example, after the selection, the view 454 can be positioned at a central position on the interface 450 with more relative prominence than the views 452, 456 while the view 452 can be positioned at a lateral position where the view 454 was formerly positioned. Many variations are possible.

FIG. 4D illustrates the example interface 450, according to an embodiment of the present technology. In this example, the user associated with the user device has again selected the view 454. The selection can indicate a user preference to direct more focus on the view 454. As a result, the media content associated with the second media content stream in the view 454 is shown more prominently and displayed in a full screen, immersive mode while the views 452, 456 are no longer shown. Appropriate instructions or commands applied to the interface 450 can resume display of the views 452, 456.

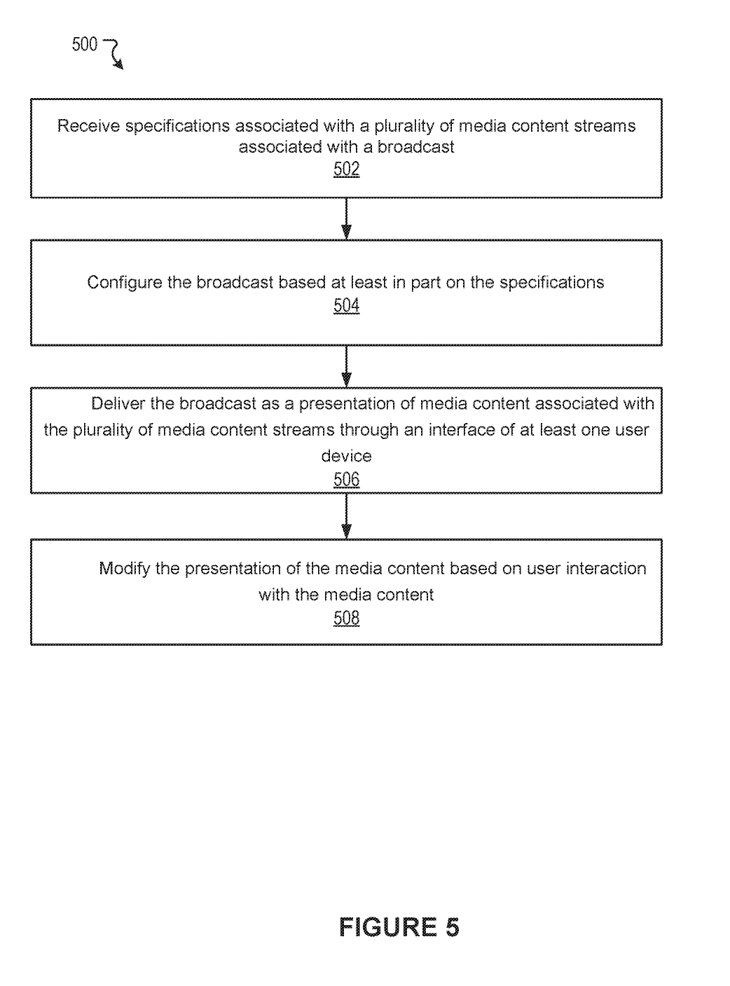

FIG. 5 illustrates an example method 500 relating to management of a broadcast, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can receive specifications associated with a plurality of media content streams associated with a broadcast. At block 504, the method 500 can configure the broadcast based at least in part on the specifications. At block 506, the method 500 can deliver the broadcast as a presentation of media content associated with the plurality of media content streams through an interface of at least one user device. At block 508, the method 500 can modify the presentation of the media content based on user interaction with the media content. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a broadcast management module 646. The broadcast management module 646 can be implemented with the broadcast management module 102, as discussed in more detail herein. In some embodiments, one or more functionalities of the broadcast management module 646 can be implemented in the user device 610.

### Hardware Implementation

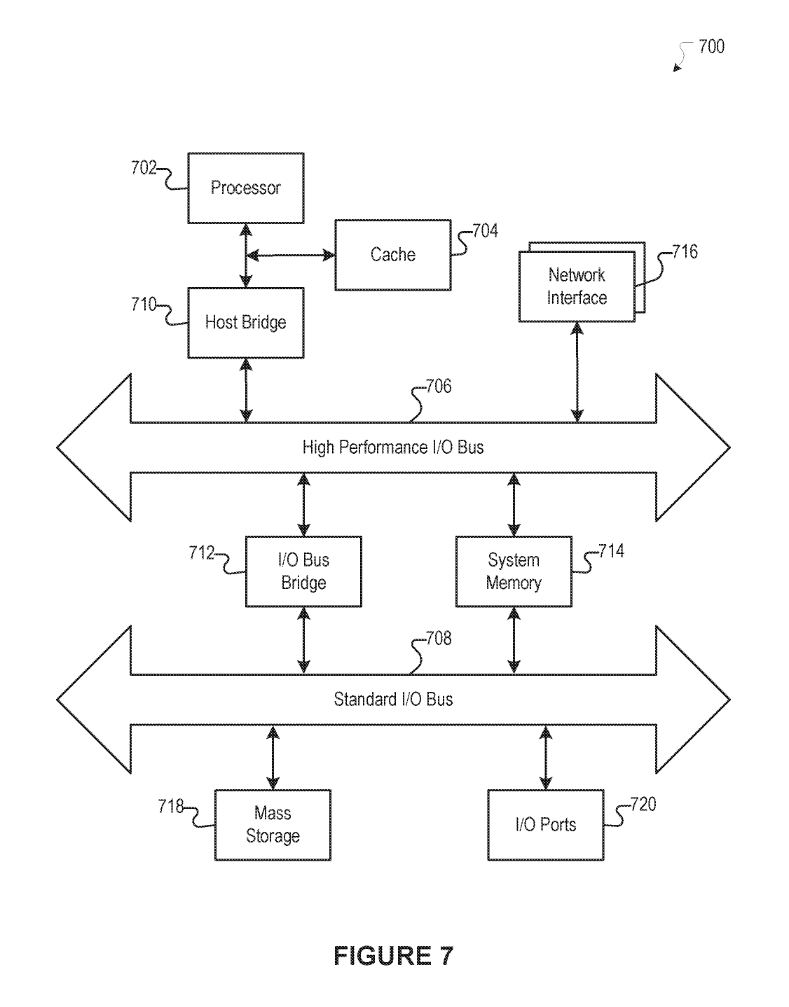

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, specifications associated with a plurality of media content streams associated with a broadcast;
configuring, by the computing system, the broadcast based at least in part on the specifications;
delivering, by the computing system, the broadcast as a presentation of media content associated with the plurality of media content streams through an interface of at least one user device; and
modifying, by the computing system, the presentation of the media content based on user interaction with the media content.

2. The computer-implemented method of claim 1, wherein the broadcast is a live broadcast.

3. The computer-implemented method of claim 1, wherein the plurality of media content streams include at least one of a video stream and an audio stream.

4. The computer-implemented method of claim 1, wherein the specifications are provided by a content provider of the plurality of media content streams.

5. The computer-implemented method of claim 1, wherein the specifications comprise at least one of a title or description associated with a media content stream, an aspect ratio associated with a media content stream, and a resolution associated with a media content stream.

6. The computer-implemented method of claim 1, wherein the configuring the broadcast comprises:
determining setup information for a content provider of the plurality of media content streams, the setup information allowing the content provider to initiate delivery of the broadcast.

7. The computer-implemented method of claim 6, wherein the setup information comprises at least one of a broadcast ID, a security key, and a URI for each media content stream of the plurality of media content streams.

8. The computer-implemented method of claim 1, further comprising:
adapting at least one media content stream of the plurality of media content streams based on contextual data, the contextual data comprising at least one of constraints associated with the at least one user device and network connectivity relating to the at least one user device, wherein the adapting comprises:
modifying metadata associated with the at least one media content stream.

9. The computer-implemented method of claim 1, wherein the presentation of the media content comprises display of media content associated with a first media content stream in a first view that is more prominent than display of media content associated with a second media content stream in a second view, the modifying the presentation of the media content comprising:
in response to a selection of the media content associated with the second media content stream in the second view, changing display of the media content associated with the second media content stream to be more prominent than the display of the media content associated with the first media content stream.

10. The computer-implemented method of claim 9, wherein the modifying the presentation of the media content further comprises:
in response to a second selection of the media content associated with the second media content stream in the second view, causing full screen display of the media content associated with the second media content stream.

11. A system comprising:
at least one processor; and
a memory storing instructions that, when executed by the at least one processor, cause the system to perform:
receiving specifications associated with a plurality of media content streams associated with a broadcast;
configuring the broadcast based at least in part on the specifications;
delivering the broadcast as a presentation of media content associated with the plurality of media content streams through an interface of at least one user device; and
modifying the presentation of the media content based on user interaction with the media content.

12. The system of claim 11, wherein the broadcast is a live broadcast.

13. The system of claim 11, wherein the plurality of media content streams include at least one of a video stream and an audio stream.

14. The system of claim 11, wherein the specifications are provided by a content provider of the plurality of media content streams.

15. The system of claim 11, wherein the specifications comprise at least one of a title or description associated with a media content stream, an aspect ratio associated with a media content stream, and a resolution associated with a media content stream.

16. A non-transitory computer-readable storage medium including instructions that, when executed by at least one processor of a computing system, cause the computing system to perform a method comprising:
receiving specifications associated with a plurality of media content streams associated with a broadcast;
configuring the broadcast based at least in part on the specifications;
delivering the broadcast as a presentation of media content associated with the plurality of media content streams through an interface of at least one user device; and
modifying the presentation of the media content based on user interaction with the media content.

17. The non-transitory computer-readable storage medium of claim 16, wherein the broadcast is a live broadcast.

18. The non-transitory computer-readable storage medium of claim 16, wherein the plurality of media content streams include at least one of a video stream and an audio stream.

19. The non-transitory computer-readable storage medium of claim 16, wherein the specifications are provided by a content provider of the plurality of media content streams.

20. The non-transitory computer-readable storage medium of claim 16, wherein the specifications comprise at least one of a title or description associated with a media content stream, an aspect ratio associated with a media content stream, and a resolution associated with a media content stream.
